(19) United States
(12) Patent Application Publication
(10) Pub. No.: US 2009/0320270 A1
(43) Pub. Date: Dec. 31, 2009

(54) METHOD AND APPARATUS FOR ASSEMBLING A CARRIAGE ASSEMBLY

(76) Inventors: Naoki Ishikawa, Kawasaki (JP); Hidehiko Kira, Kawasaki (JP); Kimio Nakamura, Kawasaki (JP); Takayoshi Matsumura, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/525,019

(22) PCT Filed: Mar. 15, 2007
(86) PCT No.: PCT/JP2007/055261

§ 371 Date: Jul. 29, 2009

(51) Int. Cl. B23P 11/00; B25B 27/00

(52) U.S. Cl. 29/505; 29/281.1

(57) ABSTRACT

There are provided a method of assembling a carriage assembly that can uniformly crimp edge portions of spacer holes of spacer portions and keep the spacer portions flat, thereby maintaining the angles of suspensions with high accuracy, and an assembling apparatus that uses such method.

The method includes an attaching step of positioning spacer holes 12b of suspensions 12 on through-holes 10a formed in front end portions of a plurality of carriage arms 10 that have been disposed in parallel and attaching the suspensions to the respective carriage arms; and a crimping step of pressing a ball 20 with a diameter that is equal to or larger than an inner diameter of the spacer holes 12b using a pressing member 40 so as to pass the ball successively through the spacer holes 12b and thereby crimp spacer hole 12b edge portions of the spacer portions 12a and attach the suspensions 12 to the carriage arms 10, wherein during the crimping step, the ball 20 is placed in a vicinity of the center axis a at least when the ball 20 is located between the carriage arms 10.

### FIELD

The present invention relates to a method of assembling a carriage assembly that is used in a magnetic disk apparatus and is constructed with suspensions attached to front end portions of carriage arms, and to an assembling apparatus that uses such method.

### BACKGROUND

FIG. 6 is a perspective view depicting a carriage assembly used in a magnetic disk apparatus. In FIG. 6, reference numeral 10 denotes a carriage arm, a plurality of which are aligned in parallel corresponding to each surface of a plurality of magnetic disks provided in the magnetic disk apparatus. An engagement hole 10a is formed in the front tip portion of each carriage arm 10. The engagement holes 10a are formed with matching center axes. Reference numeral 12 denotes a suspension that is connected to the front end of each carriage arm 10 (in FIG. 6, only one suspension 12 is depicted and the other suspensions 12 are omitted). A magnetic head 14 is mounted on a front end portion of each suspension 12. Each magnetic head 14 is electrically connected to a control unit 18 via a flexible circuit board 16 attached to a side surface of the carriage arms 10. Reference numeral 19 denotes an actuator shaft that is fixed to a base portion of each carriage arm 10. By rotating the actuator shaft 19 around its axis, each carriage arm 10 carries out a seek operation on a plane that is parallel to the surfaces of the recording media.

The carriage assembly is formed by fixing the suspensions 12 by crimping to both surfaces of the front end portions of the respective carriage arms 10 that have been attached in parallel to the actuator shaft 19.

A conventional method of fixing the suspensions 12 to the carriage arms 10 is disclosed in Patent Document 1. FIG. 7 and FIG. 8 depict the method disclosed in Patent Document 1 for fixing the suspensions 12 to the carriage arms 10.

In this method, first, a suspension 12 is attached on both the front and the rear of each carriage arm 10 with a spacer hole 12b provided in a spacer portion 12a of each suspension 12 having been positioned with respect to the engagement hole 10a formed in the front end portion of each carriage arm 10. After this, a metal ball 20 formed with a slightly larger diameter than the inner diameter of the spacer holes 12b is pressed using a pressing shaft 22 as a pressing member so as to pass through the spacer holes 12b. As depicted in FIG. 7, the metal ball 20 is thrust forward by the pressing shaft 22 so as to successively pass through inside the engagement holes 10a that have been aligned and the spacer holes 12b that have been positioned thereupon.

Since the metal ball 20 is formed with a slightly larger diameter than the spacer holes 12b, when the metal ball 20 passes through a spacer hole 12b, the metal ball 20 acts so as to press open a crimping portion 13 formed on an inner circumferential edge of the spacer hole 12b and as a result, the spacer portion 12a of the suspension 12 is fixed by crimping so as to “bite into” the carriage arm 10.

In this way, when assembling a carriage assembly, since the metal ball 20 is used to press open the spacer holes 12b and thereby fix the suspensions 12 to the carriage arms 10 by crimping, a problem may occur in that the spacer portions 12a deform due to the stress that acts thereupon during crimping, resulting in the suspensions 12 becoming displaced from the standard positions. That is, when the suspensions 12 are fixed to the carriage arms 10 by crimping, the spacer portions 12a become bent, which can result in the suspensions 12 becoming tilted with respect to the standard angle. Tilting of the suspensions 12 affects the float heights of the magnetic heads 14 above the surfaces of the recording media, resulting in fluctuations in the float heights of the magnetic heads 14 above the surfaces of the recording media.

The recording density of modem magnetic disk apparatuses has become very high in recent years, which has led to decreases in the float height of magnetic heads above the surfaces of recording media. This means that fluctuations in the float height of magnetic heads have a large effect on the information reading and writing characteristics, and therefore it is necessary to suppress fluctuations in the float height of the magnetic heads to achieve the required characteristics.

Patent Document 1 also discloses a method of assembling a carriage assembly that can suppress deformation of the spacer portions 12a due to the stress applied during crimping. FIG. 9 is a diagram useful in explaining a method of assembling a carriage assembly using an ultrasonic horn 32 which is disclosed in Patent Document 1 as a method of assembling that can suppress such deformation.

The method of assembling a carriage assembly disclosed in Patent Document 1 is characterized by using the ultrasonic horn 32 to pass the metal ball 20 through the spacer holes 12b. The metal ball 20 is the same as the metal ball 20 used in the method of assembling a carriage assembly described above. FIG. 9 depicts a state where gap maintaining plates 36 have been inserted between adjacent carriage arms 10 and pressure applying plates 37a, 37b have been placed in contact with both end surfaces of the carriage arms 10 so that the respective carriage arms 10 are supported by being sandwiched on both sides thereof.

The ultrasonic horn 32 applies ultrasonic vibration in the axial direction and due to the action of the ultrasonic horn 32, the metal ball 20 causes less damage to the spacer portions 12a during crimping. This means that deformation is prevented when the suspensions 12 are attached to the carriage arms 10 and the suspensions 12 can be fixed to the carriage arms 10 more accurately. The reason for this is thought to be that the stress caused by the ultrasonic vibration of the ultrasonic horn 32 and the static stress due to the metal ball 20 pressing open the crimping portions 13 act so as to be superimposed, which makes it possible to reduce the resistance to deformation, and by reducing the average machining force by using a striking action that is repeated at high speed, it is possible to fix the members while suppressing deformation of the fixed portions of the suspensions 12 and the carriage arms 10.

### Patent Document 1

Japanese Laid-Open Patent Publication No. 2004-127491 (see paragraphs 0003, 0004, 0015, 0023, and 0024 and FIGS. 3, 5, and 6).

### SUMMARY

However, even with the above method that passes the ball using ultrasonic vibration as described above, bending of the spacer portions 12a of the suspensions 12 can still occur. The present inventor found that this was due to the reason given below.

In conventional methods of assembling a carriage assembly that carry out crimping using a ball, since there is nothing to support the metal ball 20 when the metal ball 20 is located between the carriage arms 10 (that is, during the period from when the metal ball 20 has passed through one spacer hole 12b until the metal ball 20 is pressed inside the next spacer hole 12b by the pressing shaft 22 or the ultrasonic horn 32), as depicted by the broken line in FIG. 10, the position of the metal ball 20 (i.e., the center position of the metal ball 20) will deviate from the center axis a that joins the centers of the engagement holes 10a.

When the metal ball 20 is pressed into the next spacer hole 12b in a state where the center position of the metal ball 20 has deviated from the center axis a, the metal ball 20 will not uniformly contact the edge portion of the spacer hole 12b of the spacer portion 12a and the metal ball 20 will mainly make contact on the side to which the metal ball 20 has deviated (the lower side in FIG. 10).

In addition, since the position where the pressing shaft 22 or the ultrasonic horn 32 contacts the metal ball 20 will become eccentric with respect to the center of the metal ball 20 and a force that presses the metal ball 20 further toward the side to which the metal ball 20 has deviated (i.e., downward in FIG. 10) will act upon the metal ball 20, a larger stress will act upon the part of the edge portion of the spacer hole 12b of the spacer portion 12a on the side to which the metal ball 20 has deviated.

In this way, the present inventor found a problem in that due to the metal ball 20 (i.e., the center position of the metal ball 20) deviating from the center axis a, the spacer portions 12a become unevenly deformed during crimping, resulting in bending of the spacer portions 12a and the suspensions 12 becoming tilted with respect to the standard angle.

Note that although it would be conceivable to solve the above problem using a method that prevents the metal ball 20 from deviating from the center axis a when the metal ball 20 is located between the carriage arms 10 by making the diameter of holes 36a formed in the gap maintaining plates 36 equal to the diameter of the metal ball 20, due to fluctuations in the formation positions of the engagement holes 10a and fluctuations in the positioning of the through-holes 36a of the gap maintaining plates 36 relative to the engagement holes 10a (and the spacer holes 12b), in some cases the metal ball 20 will not be able to pass smoothly between the through-holes 36a of the gap maintaining plates 36 and the engagement holes 10a (and the spacer holes 12b), which makes this method unrealistic. This method is also susceptible to another problem in that when the diameter of the through-holes 36a is reduced, the pressing shaft 22 or the ultrasonic horn 32 will contact and damage the inner circumferential surfaces of the through-holes 36a.

The present invention was conceived to solve the problems described above and it is an object of the present invention to provide a method of assembling a carriage assembly that can uniformly crimp edge portions of spacer holes of spacer portions and keep the spacer portions flat, thereby maintaining the angles of suspensions with high accuracy, and an assembling apparatus that uses such method.

To achieve the stated object, a method of assembling a carriage assembly according to the present invention has the following construction.

That is, the method includes: an attaching step of positioning spacer holes provided in spacer portions of suspensions on through-holes formed with a matching center axis in front end portions of a plurality of carriage arms that are used in a magnetic disk apparatus and have been disposed in parallel and attaching the suspensions to the respective carriage arms; and a crimping step of pressing a ball with a diameter that is equal to or larger than an inner diameter of the spacer holes using a pressing member so as to pass the ball successively through the spacer holes of the respective suspensions and thereby crimp spacer hole edge portions of the spacer portions and attach the suspensions to the front end portions of the carriage arms, wherein during the crimping step, the ball is placed in a vicinity of the center axis, at least when the ball is located between the carriage arms.

By doing so, even when the ball is located between the carriage arms, as the ball is pressed into the next spacer hole from a position in the vicinity of the center axis of the engagement holes, the ball will uniformly contact the edge portions of the spacer holes. Accordingly, it is possible to uniformly crimp the edge portions of the spacer holes of the spacer portions and keep the spacer portions flat, and therefore maintain the angles of suspensions with high accuracy.

Also, during the crimping step, by generating an airflow that flows in a direction in which the ball passes through the spacer holes, the ball that is located between the carriage arms is fitted into a next spacer hole to be passed.

Also, the ball is made of a magnetic body, and during the crimping step, a magnet for attracting the ball is disposed in front of the ball in the direction in which the ball passes so that when the ball is located between the carriage arms, the ball is fitted into a next spacer hole to be passed.

In addition, the magnet is inserted through the spacer holes from the front in the direction in which the ball passes and moved toward the front in accordance with movement of the ball while maintaining a sufficient distance to prevent contact with the ball.

Also, during the crimping step, the carriage assembly is held so that the center axis of the through-holes is horizontal, and by generating air flows that flow upward in a vicinity of the through-holes at least between the carriage arms, the ball that is located between the carriage arms is placed in the vicinity of the center axis without falling.

Also, to achieve the stated object, an assembling apparatus for a carriage assembly according to the present invention has the following construction.

That is, the assembling apparatus includes: carriage holding means for holding a carriage assembly in a state where spacer holes provided in spacer portions of suspensions have been positioned on through-holes formed with a matching center axis in front end portions of a plurality of carriage arms that are used in a magnetic disk apparatus and have been disposed in parallel and the suspensions have been attached to the respective carriage arms; pressing means for pressing, in a direction of the center axis, a ball, which has a diameter that is equal to or larger than the inner diameter of the spacer holes, successively through the spacer holes of the suspensions to crimp edge portions of the spacer holes of the spacer portions and attach the suspensions to the front end portions of the respective carriage arms; and ball positioning means operable at least when the ball is located between the carriage arms, to place the ball in the vicinity of the center axis.

By doing so, even when the ball is located between the carriage arms, as the ball is pressed into the next spacer hole from a position in the vicinity of the center axis of the engagement holes, the ball will uniformly contact the edge portion of the spacer hole. Accordingly, it is possible to uniformly crimp the edge portions of the spacer holes of the spacer portion and keep the spacer portions flat, and therefore maintain the angles of suspensions with high accuracy,

Also, the ball positioning means generates an airflow that flows in a direction in which the ball passes through the spacer holes so that when the ball is located between the carriage arms, the ball will be fitted into a next spacer hole to be passed.

Also, the ball is made of a magnetic body, and the ball positioning means includes a magnet that is disposed at the front in the direction in which the ball passes, and by attracting the ball using the magnet, fits the ball that is located between the carriage arms, into a next spacer hole to be passed.

In addition, the ball positioning means includes magnet moving means that inserts the magnet through the spacer holes from the front in the direction in which the ball passes and moves the magnet toward the front in accordance with movement of the ball while maintaining a sufficient distance to prevent contact with the ball.

Also, the carriage holding means holds the carriage assembly so that the center axis of the through-holes is horizontal, and the ball positioning means generates air flows that flow upward in a vicinity of the through-holes at least between the carriage arms so that the ball that is located between the carriage arms is placed in the vicinity of the center axis without falling.

### EFFECT OF THE INVENTION

According to the method and apparatus for assembling a carriage assembly according to the present invention, it is possible to uniformly crimp edge portions of spacer holes of spacer portions and keep the spacer portions flat, which means that it is possible to maintain high accuracy for the angles of suspensions.

### BRIEF DESCRIPTION OF THE DRAWINGS

FIG. 1 is a diagram useful in explaining a method of assembling a carriage assembly and an assembling apparatus according to a first embodiment of the present invention.

FIG. 2 is a diagram useful in explaining another example construction of the method of assembling a carriage assembly and the assembling apparatus according to the first embodiment of the present invention.

FIG. 3 is a diagram useful in explaining a method of assembling a carriage assembly and an assembling apparatus according to a second embodiment of the present invention.

FIG. 4 is a diagram useful in explaining the method of assembling a carriage assembly and the assembling apparatus according to the second embodiment of the present invention.

FIG. 5 is a diagram useful in explaining a method of assembling a carriage assembly and an assembling apparatus according to a third embodiment of the present invention.

FIG. 6 is a perspective view of a carriage assembly.

FIG. 7 is a diagram useful in explaining an operation that fixes suspensions to carriage arms by crimping by passing a metal ball (“ball”) through spacer holes of the suspensions.

FIG. 8 is a diagram useful in explaining a method of assembling a carriage assembly.

FIG. 9 is a diagram useful in explaining a conventional method of assembling a carriage assembly.

FIG. 10 is a diagram useful in explaining a conventional method of assembling a carriage assembly.

### DESCRIPTION OF EMBODIMENTS

A carriage assembly to be assembled by the method and apparatus for assembling a carriage assembly according to the present invention is depicted in FIG. 6. Since the construction of this carriage assembly has been described in the “Background Art”, description thereof is omitted here.

### First Embodiment

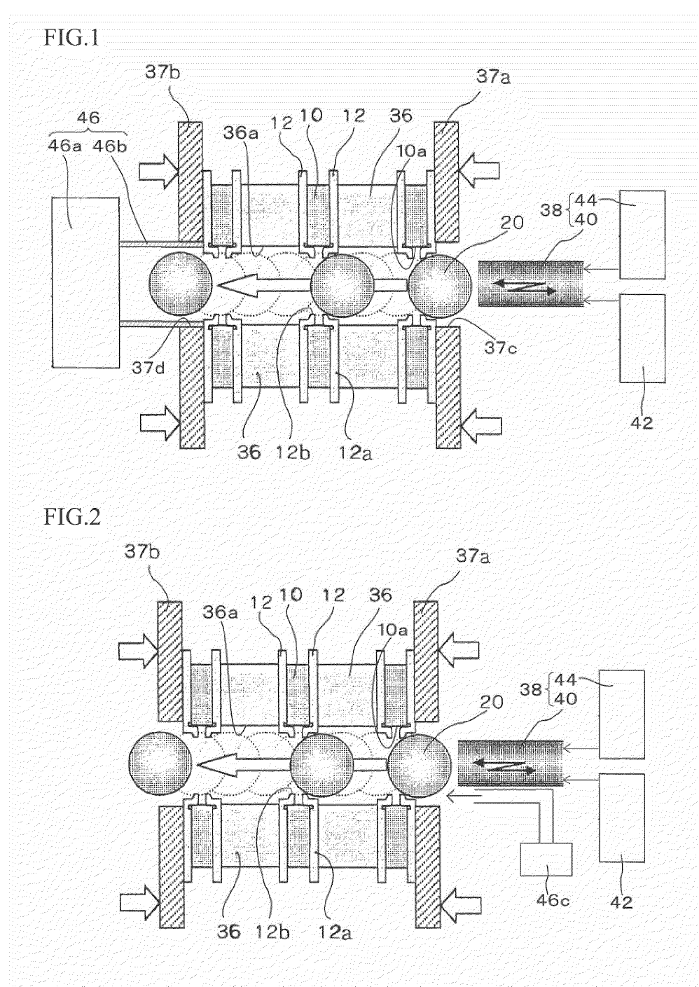

FIG. 1 is a diagram useful in explaining an apparatus for assembling a carriage assembly according to the first embodiment. The apparatus for assembling a carriage assembly according to the first embodiment includes pressure applying plates 37a, 37b as carriage holding means, gap maintaining plates 36, pressing means 38 that presses a metal ball 20, an ultrasonic vibrating device 42 as an ultrasonic vibration applying means that applies ultrasonic vibration to the metal ball 20 via a pressing member 40 (described later), and first airflow generating means 46 as a ball positioning means.

The pressure applying plates 37a, 37b as the carriage holding means clamp and support a plurality of carriage arms 10 from both sides in a state where suspensions 12 have been attached on the carriage arms 10 with spacer holes 12b of the suspensions 12 having been positioned on engagement holes 10a formed in front tip portions of the carriage arms 10 and where the gap maintaining plates 36 have been inserted between adjacent carriage arms 10.

Openings 37c, 37d are also provided in the pressure applying plates 37a, 37b respectively so as to connect to the engagement holes 10a and the spacer holes 12b when the carriage arms 10 are clamped.

The pressing means 38 is composed of a cylindrical (i.e., bar-shaped) pressing member 40 (an “ultrasonic horn”) and a driving device 44 that is capable of moving and controlling the pressing member 40. The pressing member 40 is moved and controlled along an axis thereof by the driving device 44, and is provided so as to advance into and withdraw from the engagement holes 10a of the carriage arms 10 that are clamped by the pressure applying plates 37a, 37b and the spacer holes 12b that have been positioned with respect to the engagement holes 10a along the center axis of such holes.

The ultrasonic vibrating device 42 as the ultrasonic vibration applying means includes an ultrasonic vibrator that is connected to the pressing member 40, and by causing ultrasonic vibration of the ultrasonic vibrator, ultrasonic vibration is applied to the pressing member 40. The vibration direction of the ultrasonic vibration applied by the ultrasonic vibrating device 42 is the axial direction of the pressing member 40, but is not especially limited to such.

The first airflow generating means 46 as the ball positioning means includes a pump 46a that evacuates air and a pipe 46b that is connected to the pump 46a and acts as an air intake. A front end portion of the pipe 46b is attached to one of the pressure applying plates 37b by means of an airtight connection to the opening 37d of the pressure applying plate 37b.

Next, the method of assembling a carriage assembly using the assembling apparatus for a carriage assembly according to the first embodiment will be described.

### Attaching Process

First, the suspensions 12 are attached with the spacer holes having been positioned on the respective engagement holes 10a formed in the front end portions of the carriage arms 10 so as to match the engagement holes 10a. The suspensions 12 are attached on both the front and the rear of each carriage arm 10 aside from the carriage arms 10 at both ends out of the carriage arms 10 disposed in parallel.

Next, the carriage assembly is held by the assembling apparatus for a carriage assembly. That is, as depicted in FIG. 1, a state is produced where the gap maintaining plates 36 are inserted between adjacent carriage arms 10, the pressure applying plates 37a, 37b are placed in contact with both end surfaces of the carriage arms 10, and the carriage arms 10 are held by being sandwiched on both sides.

### Crimping Process

In this state, the metal ball 20 is passed through the spacer holes 12b by the pressing means 38.

That is, first, the metal ball 20 is positioned with respect to the spacer hole 12b of the suspension 12 attached to the endmost carriage arm 10 out of the aligned carriage arms 10 (in this example, the carriage arm 10 on the pressure applying plate 37a side) and is disposed on one side of the spacer hole 12b. After this, the pressing member 40 is moved and controlled by the driving device 44 so that the front end portion of the pressing member 40 comes into contact with the metal ball 20 and the pressing member 40 is moved so as to be inserted into the spacer hole 12b. At this time, the ultrasonic vibrating device 42 is driven to apply ultrasonic vibration to the pressing member 40 while successively passing the metal ball 20 through the respective spacer holes 12b.

Since the metal ball 20 is formed with a slightly larger diameter than the spacer holes 12b, when the metal ball 20 passes through a spacer hole 12b, a crimping portion 13 formed at the inner circumferential edge of the spacer hole 12b is pressed open, and by doing so, the spacer portion 12a of the suspension 12 is crimped and fixed so as to bite into the carriage arm 10.

In the method of assembling a carriage assembly according to the first embodiment, during the crimping process, by driving the first airflow generating means 46 to evacuate air from inside the engagement holes 10a, the spacer holes 12b, and the through-holes 36a of the gap maintaining plates, an air flow that flows in the direction in which the metal ball 20 passes inside the spacer holes 12b is generated.

By doing so, when the metal ball 20 is located between the carriage arms 10 (that is, during the period from when the metal ball 20 has passed through one spacer hole 12b until the metal ball 20 is pressed inside the next spacer hole 12b by the pressure-applying member 40), the metal ball 20 is pulled by the airflow and fitted inside the next spacer hole 12b.

Once the metal ball 20 has fitted into the spacer hole 12b to be passed next, the position of the metal ball (the center position of the metal ball) will not deviate from the center axis a that joins the centers of the engagement holes 10a as happened in the background art.

Accordingly, when the metal ball 20 is pressed by the pressure-applying member 40 into the spacer hole 12b, the metal ball 20 will uniformly contact the edge portion of the spacer hole 12b of the spacer portion 12a. By doing so, the edge portions of the spacer holes 12b will be uniformly crimped without a non-uniform force being applied to the edge portions of the spacer holes 12b during crimping, and therefore the spacer portions can be kept flat and the angles of the suspensions can be maintained with high accuracy.

Note that it is preferable to provide the pump 46a or the pipe 46b with a means for removing the metal ball 20 after the crimping process has ended. For example, it is possible to use a mechanism where a mesh member with a mesh of a sufficient size to allow air to pass but prevent the metal ball 20 from passing is provided on the air path inside the pump 46a or the pipe 46b and the metal ball 20 is removed after catching on the mesh member.

Also, in the first embodiment, instead of a construction that evacuates air from the front in the direction in which the metal ball 20 passes as depicted in FIG. 1, the first airflow generating means 46 as the ball positioning means may be constructed so as to expel air into the spacer holes 12b from behind in the direction in which the metal ball 20 passes. For example, as depicted in FIG. 2, as the first airflow generating means 46, it is possible to provide a blower 46c that expels compressed air from behind in the direction in which the metal ball 20 passes. With this construction also, during the crimping process, by generating an airflow that flows through the spacer holes 12b in the direction in which the metal ball 20 passes, it is possible to fit the metal ball 20 that is located between the carriage arms 10 into the next spacer hole 12b to be passed.

### Second Embodiment

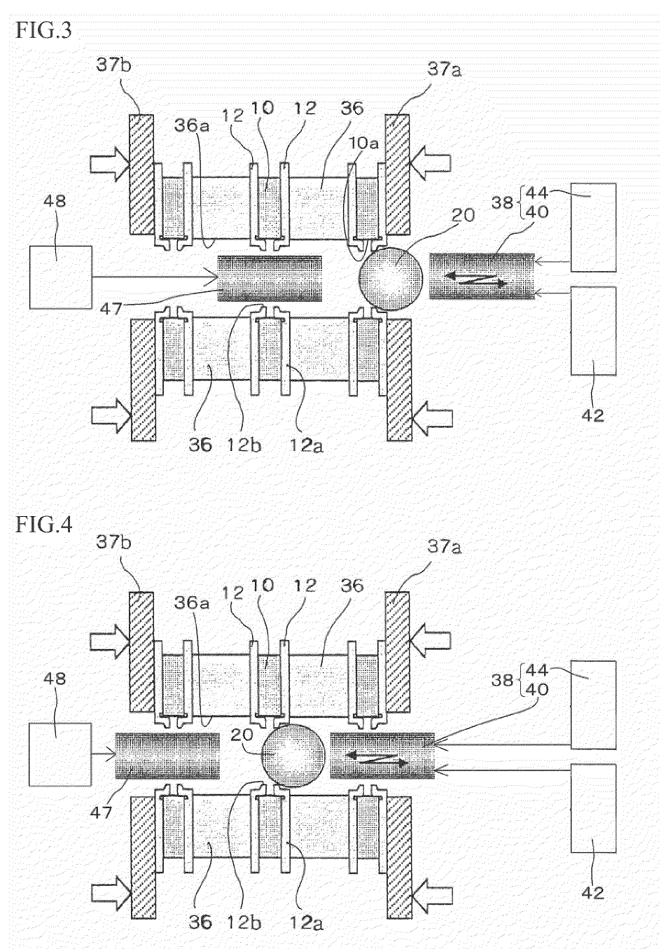

Next, a method of assembling a carriage assembly and an assembling apparatus according to a second embodiment will be described with reference to FIGS. 3 and 4. Note that in the second embodiment, constructions that are the same as in the first embodiment have been assigned the same reference numerals and description thereof is omitted.

As depicted in FIG. 3, as the ball positioning means, in place of the first airflow generating means 46 of the first embodiment, the assembling apparatus of a carriage assembly according to the second embodiment includes a magnet 47 that is disposed at the front in the direction in which the metal ball 20 passes and magnet moving means 48 that moves the magnet 47.

The magnet 47 is a permanent magnet or an electromagnet and is formed in a shape, such as a cylindrical bar, that is capable of advancing inside the spacer holes 12b. The magnet 47 is moved and driven by the magnet moving means 48 along the axis of the magnet 47 so as to advance into and withdraw from the engagement holes 10a of the carriage arms 10 clamped by the pressure applying plates 37a, 37b and the spacer holes 12b that have been positioned on the engagement holes 10a along the center axis of such holes.

The magnet 47 is provided so as to advance inside the spacer holes 12b from the front in the direction in which the metal ball 20 is passed by the pressing means 38. Putting this another way, the magnet 47 is provided so as to advance inside the spacer holes 12b from the other end (the pressure applying plate 37b end) of the carriage assembly to the end (the pressure applying plate 37a end) from which the metal ball 20 advances.

During the crimping process, the magnet moving means 48 carries out control so that the magnet 47 is moved from a state where the magnet 47 has been inserted inside a spacer hole 12b toward the front in the direction in which the ball passes in accordance with the movement of the ball while maintaining a sufficient distance to prevent contact with the metal ball 20.

That is, from the state depicted in FIG. 3, once the metal ball 20 has passed through the first spacer hole 12b, as depicted in FIG. 4, the magnet moving means 48 moves the magnet 47 so as to track the movement of the pressure-applying member 40 and move to a position further forward than the spacer hole 12b to be passed next by the metal ball 20.

According to the construction of the second embodiment, when the metal ball 20 is located between the carriage arms 10 (that is, during the period from when the metal ball 20 has passed through one spacer hole 12b until the metal ball 20 is pressed inside the next spacer hole 12b by the pressure-applying member 40), the magnet 47 attracts the metal ball 20 that is composed of a magnetic body, which results in the metal ball 20 being fitted into the next spacer hole 12b.

The effect due to the metal ball 20 being fitted into the next spacer hole 12b is the same as in the first embodiment.

Also, since the magnet 47 is moved by the magnet moving means 48 in accordance with the movement of the metal ball 20, the magnet 47 will always be close to the metal ball 20 so that a strong and substantially constant magnetic field will act upon the metal ball 20. This means that it is possible to stably and continually attract the metal ball 20.

Note that the magnet 47 does not necessarily need to be moved in accordance with movement of the metal ball 20 and as one example, it is possible to use a construction where a magnet that generates a strong magnetic field is provided outside the spacer holes 12b (on the pressure applying plate 37b side) at the front in the direction in which the metal ball 20 passes.

### Third Embodiment

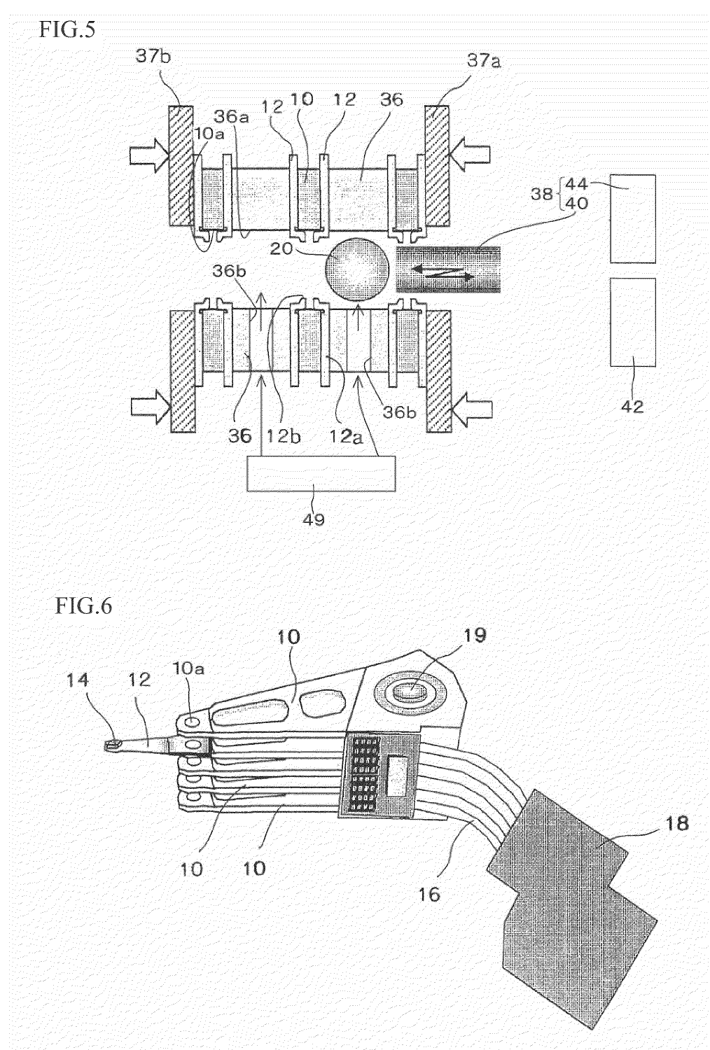

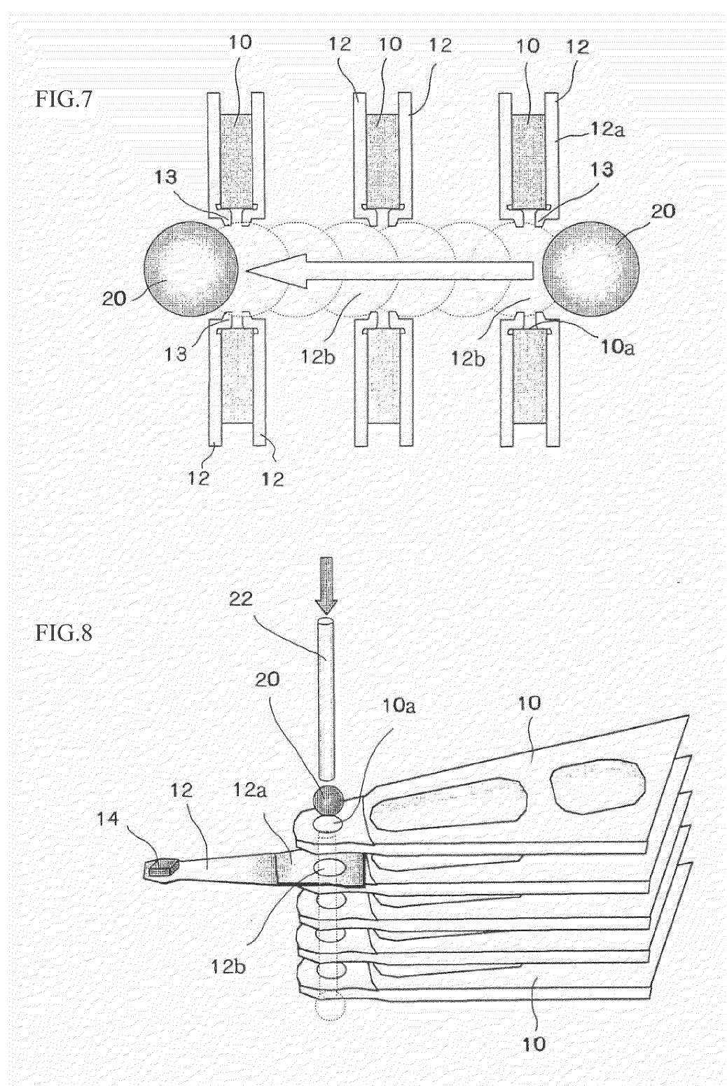

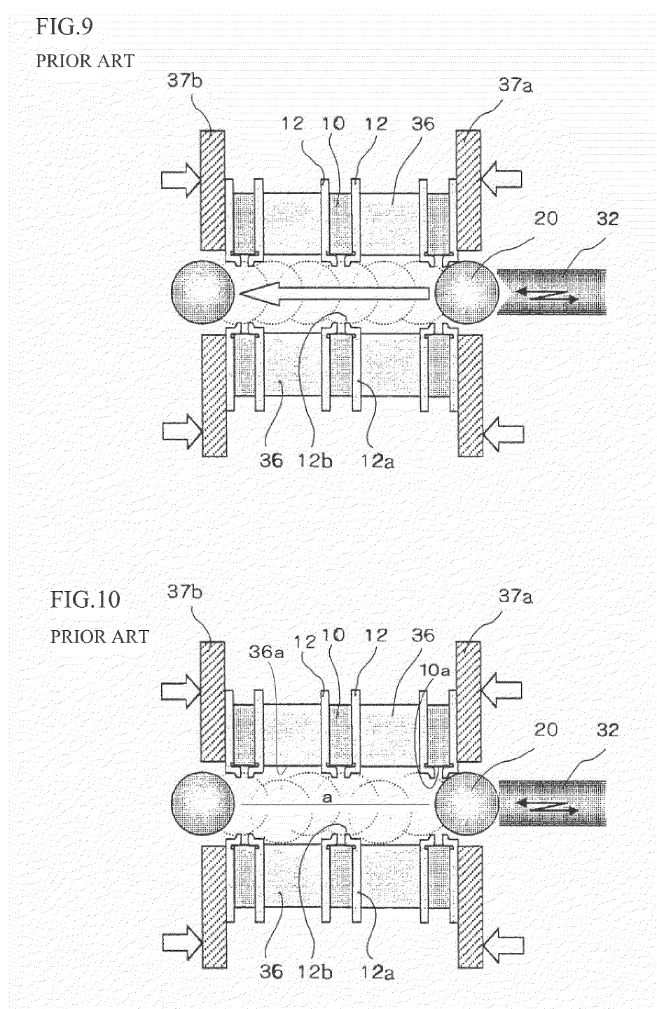

Next, a method of assembling a carriage assembly and an assembling apparatus according to a third embodiment will be described with reference to FIG. 5. Note that in the third embodiment, constructions that are the same as in the first embodiment have been assigned the same reference numerals and description thereof is omitted.

In the assembling apparatus for a carriage assembly according to the third embodiment, the pressure applying plates 37a, 37b as the carriage holding means are provided so as to hold the carriage assembly before assembly so that the center axis a of the engagement holes 10a is horizontal.

If this is the premise, during the crimping process, when located between the carriage arms 10, the metal ball 20 will fall under gravity until the metal ball 20 contacts the inner circumference of the through-hole 36a of one of the gap maintaining plates 36, and will therefore deviate from the center axis a.

In the third embodiment, to prevent the above from happening, as depicted in FIG. 5, as the ball positioning means, in place of the first airflow generating means 46 of the first embodiment, a second airflow generating means 49 is provided to generate airflows that flow upward in the vicinity of the engagement holes 10a of the carriage arms 10.

The second airflow generating means 49 uses a blower to generate airflows that flow upward between the carriage arms 10 in the vicinity of the engagement holes 10a via through-holes 36b formed in lower portions of the gap maintaining plates 36 so as to connect the insides and outsides of the through-holes 36a. Due to these airflows, when the metal ball 20 is located between the carriage arms 10, the metal ball 20 will float inside a through-hole 36a and become positioned in the vicinity of the center axis a without falling.

If the metal ball 20 is pressed into the next spacer hole 12b by the pressure-applying member 40 in a state where the metal ball 20 is floating without falling inside the through-hole 36a and is therefore in the vicinity of the center axis a, the metal ball 20 will be pressed so as to uniformly contact the edge portion of the spacer hole 12b without deviating from the center axis a. By doing so, the edge portion of the spacer hole 12b can be uniformly crimped and the flatness of the spacer portion can be maintained without a non-uniform force being applied to the edge portion of the spacer hole 12b during crimping, and it is therefore possible to maintain high accuracy for the angles of the suspensions.

Also, in the third embodiment, instead of being constructed so as to evacuate air from the front in the direction in which the metal ball 20 passes, the second airflow generating means 49 as the ball positioning means may be constructed so as to evacuate air from upper through-holes formed in the gap maintaining plates 36. With this construction also, during the crimping process, airflows that flow upward are generated between the carriage arms 10 in the vicinity of the engagement holes 10a to cause the metal ball 20 to float and become placed in the vicinity of the center axis a.

1. A method of assembling a carriage assembly comprising:
an attaching step of positioning spacer holes provided in spacer portions of suspensions on through-holes formed with a matching center axis in front end portions of a plurality of carriage arms that are used in a magnetic disk apparatus and have been disposed in parallel and attaching the suspensions to the respective carriage arms; and
a crimping step of pressing a ball with a diameter that is equal to or larger than an inner diameter of the spacer holes using a pressing member so as to pass the ball successively through the spacer holes of the respective suspensions and thereby crimp spacer hole edge portions of the spacer portions and attach the suspensions to the front end portions of the carriage arms,
wherein during the crimping step, the ball is placed in a vicinity of the center axis, at least when the ball is located between the carriage arms.

2. A method of assembling a carriage assembly according to claim 1,
wherein during the crimping step, an airflow that flows in a direction in which the ball passes through the spacer holes is generated so that when the ball is located between the carriage arms, the ball will be fitted into a next spacer hole to be passed.

3. A method of assembling a carriage assembly according to claim 1,
wherein the ball is made of a magnetic body, and
during the crimping step, a magnet for attracting the ball is disposed in front of the ball in the direction in which the ball passes so that when the ball is located between the carriage arms, the ball will be fitted into a next spacer hole to be passed.

4. A method of assembling a carriage assembly according to claim 3,
wherein the magnet is inserted through the spacer holes from the front in the direction in which the ball passes and is moved toward the front in accordance with movement of the ball while maintaining a sufficient distance to prevent contact with the ball.

5. A method of assembling a carriage assembly according to claim 1,
wherein during the crimping step, the carriage assembly is held so that the center axis of the through-holes is horizontal, and
by generating air flows that flow upward in a vicinity of the through-holes at least between the carriage arms, the ball that is located between the carriage arms is placed in the vicinity of the center axis without falling.

6. An assembling apparatus for a carriage assembly, comprising:
carriage holding means for holding a carriage assembly in a state where spacer holes provided in spacer portions of suspensions have been positioned on through-holes formed with a matching center axis in front end portions of a plurality of carriage arms that are used in a magnetic disk apparatus and have been disposed in parallel and the suspensions have been attached to the respective carriage arms;
pressing means for pressing, in a direction of the center axis, a ball, which has a diameter that is equal to or larger than the inner diameter of the spacer holes, successively through the spacer holes of the suspensions to crimp edge portions of the spacer holes of the spacer portions and attach the suspensions to the front end portions of the respective carriage arms; and
ball positioning means operable at least when the ball is located between the carriage arms, to place the ball in the vicinity of the center axis.

7. An assembling apparatus for a carriage assembly according to claim 6,
wherein the ball positioning means generates an airflow that flows in a direction in which the ball passes through the spacer holes so that when the ball is located between the carriage arms, the ball will be fitted into a next spacer hole to be passed.

8. An assembling apparatus for a carriage assembly according to claim 6,
wherein the ball is made of a magnetic body, and
the ball positioning means includes a magnet that is disposed at the front in the direction in which the ball passes, and by attracting the ball using the magnet, fits the ball that is located between the carriage arms, into a next spacer hole to be passed.

9. An assembling apparatus for a carriage assembly according to claim 8,
wherein the ball positioning means includes magnet moving means that inserts the magnet through the spacer holes from the front in the direction in which the ball passes and moves the magnet toward the front in accordance with movement of the ball while maintaining a sufficient distance to prevent contact with the ball.

10. An assembling apparatus for a carriage assembly according to claim 6,
wherein the carriage holding means holds the carriage assembly so that the center axis of the through-holes is horizontal, and
the ball positioning means generates air flows that flow upward in a vicinity of the through-holes at least between the carriage arms so that the ball that is located between the carriage arms is placed in the vicinity of the center axis without falling.
